(19) United States
(12) Patent Application Publication
(10) Pub. No.: US 2006/0238370 A1
(43) Pub. Date: Oct. 26, 2006

(54) RFID reader for RFID tag related information and method thereof

(75) Inventors: Kyung-ho Park, Suwon-si (KR); Woo-shik Kang, Suwon-si (KR); Hyung-min Yoon, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/408,928

(22) Filed: Apr. 24, 2006

(30) Foreign Application Priority Data
Apr. 26, 2005 (KR) 10-2005-0034753
Mar. 27, 2006 (KR) 10-2006-0027349

(51) Int. Cl. H04Q 5/22; G08B 1/00

(52) U.S. Cl. 340/825.49; 340/539.2; 340/539.21; 340/10.41

(57) ABSTRACT

A radio frequency identification (RFID) reader for offering tag related information and a method thereof are provided. The RFID reader includes a communicator which receives a radio frequency (RF) signal from an RFID tag, a controller which calculates location information of the RFID tag on the basis of the RF signal, and a display information generator which processes the location information of the RFID tag to be displayed on a display. Accordingly, even when a plurality of RFID tags are located around the reader, a user can identify the RFID tags with the identifications (IDs) of the RFID tags read by the reader.

### CROSS-REFERENCE TO RELATED APPLICATIONS

This application claims priority from Korean Patent Application No. 10-2005-0034753 filed on Apr. 26, 2005, and Korean Patent Application No. 10-2006-0027349 filed on Mar. 27, 2006 in the Korean Intellectual Property Office, the entire disclosure of which is incorporated herein by reference.

### BACKGROUND OF THE INVENTION

1. Field of the Invention

Apparatuses and methods consistent with the present invention relate to a radio frequency identification (RFID) reader and a method for offering RFID tag related information, and more particularly, to an RFID reader that can offer tag related information such as location information on RFID tag and information on a product, to which RFID tag is attached, and a method for offering the RFID tag related information.

2. Description of the Related Art

As radio technology has been developed, various RFID systems have been utilized such as prepaid bus cards, parking lot admission tickets and identification (ID) cards to laboratory.

The RFID is performed basically by exchanging RF signals between a reader and a tag. In detail, if a tag ID of a tag memory is output as an RF signal, the reader receives, checks and reads the information.

Conventionally, the RFID system has a fixed reader and a moving tag. In this case, only one tag approaches the reader at a time so that the reader can read only one tag ID at a time. As a result, a user can clearly identify a tag with the ID read by the reader.

However, the recent RFID system can have a fixed tag and a mobile reader. In this case, if the reader moves to a location with a plurality of tags, the reader reads the plurality of tag IDs at a time. Accordingly, a user cannot identify the tags with the IDs read by the reader.

### SUMMARY OF THE INVENTION

The present invention provides an RFID reader that can offer location information on an RFID tag, and information on a product to which the RFID tag is attached as RFID tag related information so that the RFID tag can be easily identified when a plurality of tags exist around a reader, and a method for offering RFID tag related information.

According to an aspect of the present invention, there is provided an RFID reader including a communicator which receives a radio frequency (RF) signal from an RFID tag, a controller which calculates location information of the RFID tag based on the RF signal, and a display information generator which processes the location information of the RFID tag for display.

The location information of the RFID tag may include at least one of distance information and direction information, wherein the distance information is information regarding a distance between the RFID tag and the RFID reader, and the direction information is information regarding a direction of the RFID reader toward the RFID tag.

The RFID reader may further include a measurer which measures a magnitude of the RF signal received through the communicator. The controller may calculate the at least one of the distance information and the direction information using the magnitude of the RF signal.

The controller may calculate the at least one of the distance information and the direction information using an average of magnitudes of the RF signal which are measured for a plurality of times by the measurer.

The location information of the RFID tag may include at least one of a location of the RFID tag on the earth, an address of a product to which the RFID tag is attached, an absolute location of the RFID tag and a relative location of the RFID tag. Here, the absolute location is a location where location relationship with another product is not considered and the relative location is a location where the location relationship with another product is considered.

The location information of the RFID tag may be stored in a memory of the RFID tag, and the RF signal may have the location information of the RFID tag.

The display information generator may process the location information of the RFID tag such that the location information of the RFID tag is displayed on a display using a symbol of the RFID tag and a symbol of the RFID reader.

The controller may detect product information which is information on a product to which the RFID tag is attached, and included in the RF signal, and the display information generator may process the product information such that the product information is displayed together with the location information of the RFID tag on a display.

According to an aspect of the present invention, there is provided an RFID reader including a communicator which receives an RF signal including product information, which is information on a product to which an RFID tag is attached, from the RFID tag, a controller which detects the product information from the RF signal, and a display information generator which processes the product information for display.

The product information, which is included in the RF signal, may be stored in a memory of the RFID tag.

According to an aspect of the present invention, there is provided an RFID tag including a memory which stores product information, which is information on a product to which an RFID tag is attached, and a communicator which generates a radio frequency (RF) signal including the product information, and transmits the RF signal to an RFID reader.

The memory may further store language information on the product information, and the RF signal may further include the language information.

According to an aspect of the present invention, there is provided a method for offering RFID tag related information, the method including operations of a) receiving an RF signal from an RFID tag, b) calculating location information of the RFID tag on the basis of the received RF signal, and c) processing the location information of the RFID tag for display.

The location information of the RFID tag may include at least one of distance information and direction information. The distance information is information regarding a distance between the RFID tag and the RFID reader, and the direction information is information regarding a direction of the RFID reader toward the RFID tag.

Operation b) may include operations of measuring a magnitude of the received RF signal, and calculating at least one of the distance information and the direction information using the magnitude of the RF signal.

In calculating the at least one of the distance information and the direction information, an average of magnitudes of the RF signal, which are measured for a plurality of times, may be used.

The location information of the RFID tag may include at least one of a location of the RFID tag on the earth, an address of a product to which the RFID tag is attached, an absolute location of the RFID tag, and a relative location of the RFID tag. Here, the absolute location is a location where location relationship with another product is not considered and the relative location is a location where the location relationship with another product is considered.

The location information of the RFID tag may be stored in a memory of the RFID tag, and the RF signal may have the location information of the RFID tag.

In operation c), a symbol of the RFID tag and a symbol of the RFID reader may be used in displaying the location information of the RFID tag.

The method may further include operations of detecting product information, which is information on a product to which the RFID tag is attached, and included in the RF signal, and processing the product information such that the product information is displayed together with the location information of the RFID tag.

According to an aspect of the present invention, there is provided a method for offering RFID tag related information, the method including operations of receiving an RF signal including product information, which is information on a product to which an RFID tag is attached, from the RFID tag, detecting the product information from the RF signal, and processing the product information for display.

### BRIEF DESCRIPTION OF THE DRAWINGS

The above aspects and features of the present invention will be more apparent by describing certain embodiments of the present invention with reference to the accompanying drawings, in which:

FIG. 1 is a view illustrating an example of an RFID system according to an exemplary embodiment of the present invention;

FIG. 2 is a block diagram illustrating a reader, which offers distance information of a tag, and a tag according to an exemplary embodiment of the present invention;

FIG. 3 is a flowchart explaining a method for offering tag distance information according to an exemplary embodiment of the present invention;

FIGS. 4A and 4B are views for further explaining the tag distance information offering method according to an exemplary embodiment of the present invention;

FIG. 5 is a block diagram illustrating a reader, which offers direction information of a tag, and a tag according to another exemplary embodiment of the present invention;

FIG. 6 is a flowchart for explaining a method for offering tag direction information according to another exemplary embodiment of the present invention;

FIGS. 7A and 7B are views for further explaining a method for offering the tag direction information according to another exemplary embodiment of the present invention;

FIGS. 8A and 8B are views for explaining a method for offering the tag distance information and the tag direction information according to still another exemplary embodiment of the present invention;

FIG. 9 is a block diagram illustrating a reader, which offers tag related information on a product, and a tag according to yet another exemplary embodiment of the present invention;

FIG. 10 is a flowchart for explaining a method for offering tag product information according to another exemplary embodiment of the present invention;

FIG. 11A is a view for further explaining a method for offering the tag product information according to an exemplary embodiment of the present invention; and

FIG. 11B is a view for explaining a method for offering the tag distance information, the tag direction information and the tag product information according to an exemplary embodiment of the present invention.

### DETAILED DESCRIPTION OF THE EXEMPLARY EMBODIMENTS

Exemplary embodiments of the present invention will be described in detail with reference to the annexed drawings. In the drawings, the same elements are denoted by the same reference numerals throughout the drawings. In the following description, detailed descriptions of known functions and configurations incorporated herein have been omitted for conciseness and clarity.

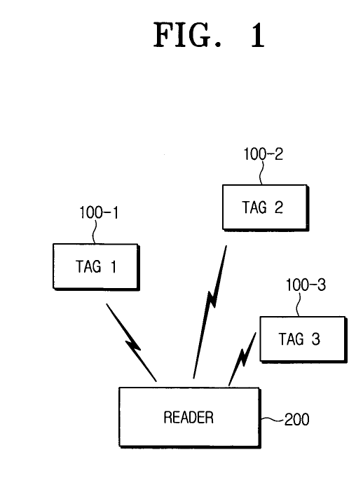

An RFID system according to an exemplary embodiment of the present invention comprises a plurality of RFID readers (hereafter, referred to ‘reader’), and a plurality of RFID tags (hereafter, referred to ‘tag’). FIG. 1 is a view illustrating an example of the RFID system according to an exemplary embodiment of the present invention, in which the RFID system comprises one reader 200 and three tags 100-1, 100-2 and 100-3.

The reader 200 transmits and receives RF signals to and from the tags 100-1, 100-2 and 100-3 so that it can read the IDs of the tags 100-1, 100-2 and 100-3 and inform a user of the IDs.

The reader 200 can also inform a user of information on locations of tags 100-1, 100-2 and 100-3 and information on products with tags 100-1, 100-2 and 100-3 as tag related information. The location information of tags includes information on a distance between the tag and the reader (hereafter, referred to ‘tag distance information’), and information on a direction of the reader toward the tag (hereafter, referred to ‘tag direction information’).

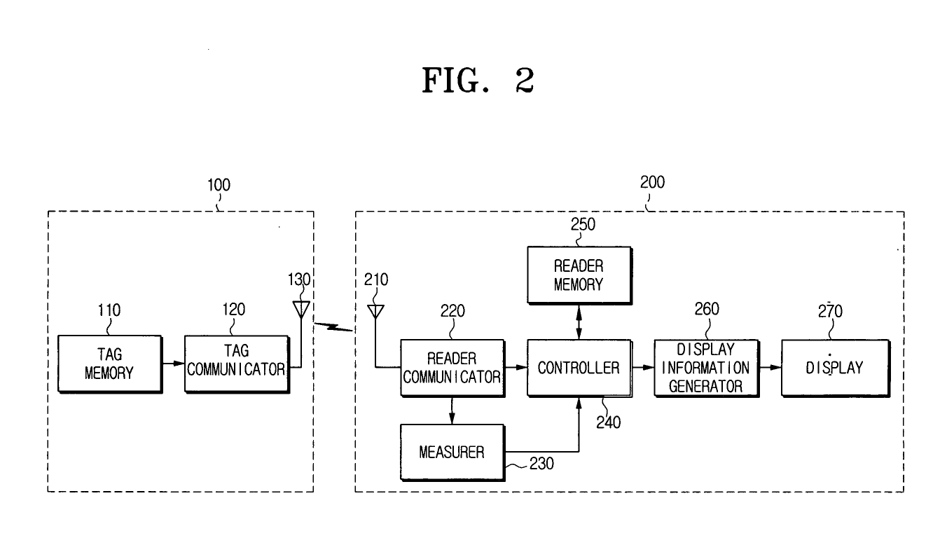

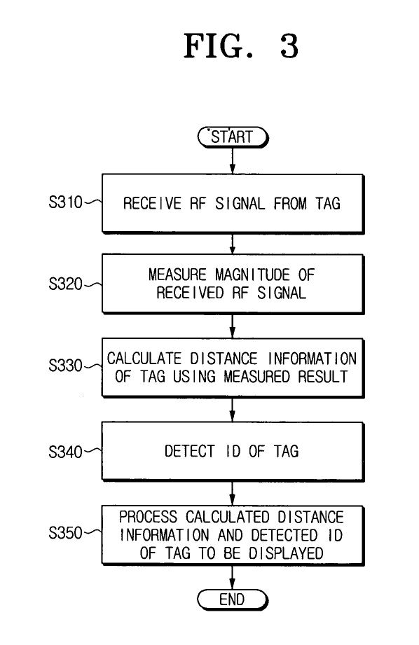

Hereafter, the process of the reader 200 offering the tag distance information as the tag related information will be elucidated with reference to FIGS. 2 and 3. FIG. 2 is a block diagram illustrating a reader, which offers the tag distance information, and a tag according to an exemplary embodiment of the present invention.

More specifically, FIG. 2 is a more detailed block diagram showing the RFID system illustrated in FIG. 1. The tags 100-1, 100-2 and 100-3 illustrated in FIG. 1 have the same constructions, and accordingly, FIG. 2 illustrates only one tag 100 for the convenience of explanation, and the tag 100 will be explained as a representative of all the tags 100-1, 100-2 and 100-3.

Referring to FIG. 2, the tag 100 comprises a tag memory 110, a tag communicator 120, and a tag antenna 130. The tag memory 110 stores a tag ID. The tag communicator 120 generates an RF signal including the tag ID of the tag memory 110, and transmits the generated RF signal through the tag antenna 130 to the reader 200.

The reader 200 comprises a reader antenna 210, a reader communicator 220, a measurer 230, a controller 240, a reader memory 250, a display information generator 260 and a display 270.

The reader communicator 220 receives the RF signal through the antenna 210 from the tag 100, demodulates and digitizes the received signal, and transmits the digitized signal to the controller 240, which will be explained below.

The measurer 230 measures a magnitude of the RF signal received through the reader communicator 220, and transmits the measured result to the controller 240.

The controller 240 calculates the tag distance information using the measured result received from the measurer 230. The controller 240 also detects the ID of the tag 100 from an output signal of the reader communicator 220.

The display information generator 260 processes the tag distance information, which is calculated by the controller 240, and the ID of tag 100, which is detected by the controller 240, so that the tag distance information and the ID can be displayed on the display 270 for the user's notice.

The reader memory 250 is a recording medium that stores therein programs and data necessary for operating the reader 200.

Hereafter, the process of the reader 200 offering the distance information of the tag 100 will be elucidated with reference to FIG. 3. FIG. 3 is a flowchart for explaining the method for offering the tag distance information according to an exemplary embodiment of the present invention.

Referring to FIG. 3, the reader communicator 220 receives an RF signal from the tag 100 (S310). The measurer 230 measures the magnitude of the RF signal received through the reader communicator 220 (S320).

The controller 240 calculates the tag distance information using the measured result of the measurer 230 (S330). As aforementioned, the tag distance information refers to the information on the distance between the tag 100 and the reader 200.

The distance between the tag 100 and the reader 200 and the magnitude of the RF signal measured by the measurer 230 are inversely proportional to each other. In detail, as the distance between the tag 100 and the reader 200 gets shorter, the magnitude of the RF signal measured by the measurer 230 becomes greater, and as the distance between the tag 100 and the reader 200 gets longer, the magnitude of the RF signal measured by the measurer 230 becomes smaller.

Under this circumstance, the controller 240 calculates the tag distance information using the measured result received from the measurer 230. In more detail, the controller 240 can calculate the tag distance information corresponding to the measured result using ‘magnitude-distance table’ pre-stored in the reader memory 250. The ‘magnitude-distance table’ shows 1:1 corresponding relationship between ‘the magnitude of the RF signal measured by the measurer 230’ and ‘the distance between the tag 100 and the reader 200’.

The controller 240 detects the ID of tag 100 from the output signal, which is processed and output by the reader communicator 220 (S340).

The display information generator 260 processes the tag distance information, which is calculated by the controller 240, and the ID of the tag 100, which is detected by the controller 240, so that the tag distance information and the ID can be displayed on the display 270 (S350).

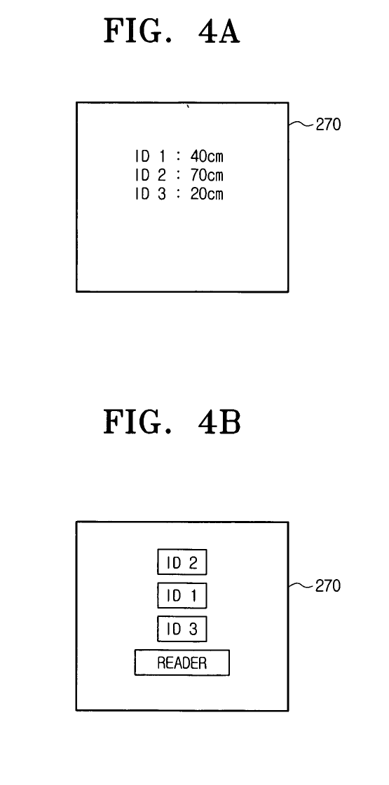

FIG. 4A shows the result of operation S350 when three tags 100-1, 100-2 and 100-3 are located around the reader 200 as illustrated in FIG. 1. Referring to FIG. 4A, the display 270 displays ID1, ID2 and ID3, which are IDs of each tag, together with 40 cm, 70 cm and 20 cm, which are the distance information of each tag 100-1, 100-2 and 100-3.

When processing the tag distance information such as 40 cm, 70 cm and 20 cm and tag IDs such as ID1, ID2 and ID3 in the operation S350, the display information generator 260 can illustratively process them using symbols of the tags 100-1, 100-2 and 100-3, and a symbol of the reader 200. According to this, information can be more effectively-visually offered to a user.

In FIG. 4B, the word ‘reader’ is displayed in a block to represent the reader 200, and ‘ID1’, ‘ID2’ and ‘ID3’ are displayed in blocks to represent the tags 100-1, 100-2 and 100-3. The distance between the symbol of the reader 200 and the symbols of the tags 100-1, 100-2 and 100-3 is adjusted proportionally to the calculated tag distance information. Accordingly, the distance information and the IDs of the tags 100-1, 100-2, and 100-3 can be illustratively displayed.

Referring to FIG. 4B, the symbol ‘ID3’ of the tag 3 100-3, which is the nearest to the reader 200, is displayed to be the nearest to the symbol of the reader 200, and the symbol ‘ID2’ of the tag 2 100-2, which is the furthest from the reader 200, is displayed to be the furthest from the symbol of the reader 200.

Meanwhile, the operations S310 and S320 may be repeated for a predetermined number of times. In the operation S330, the magnitudes of the RF signals may be obtained by several measurements, and the tag distance information may be calculated using the average.

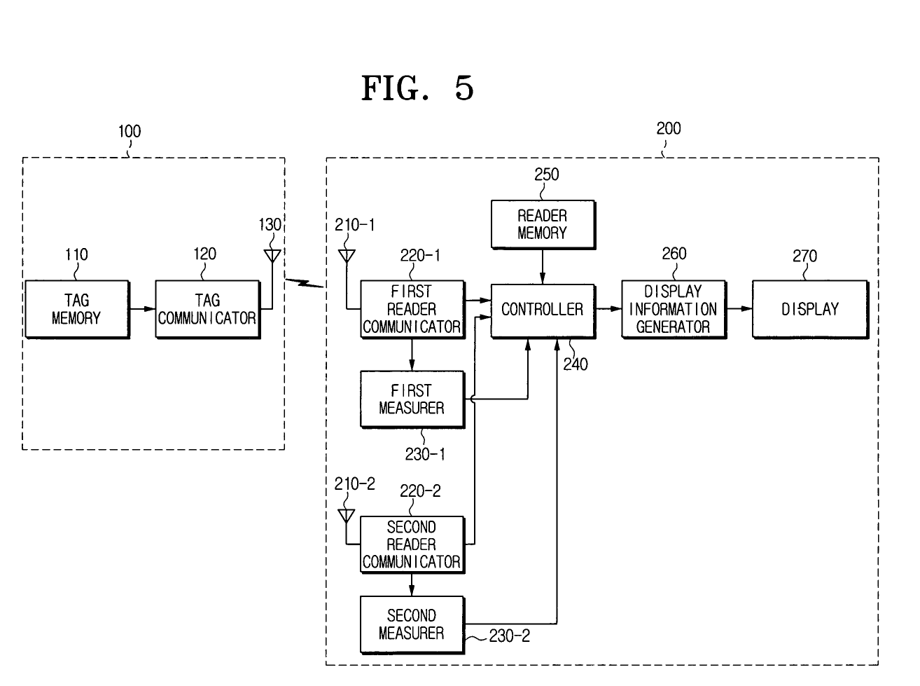

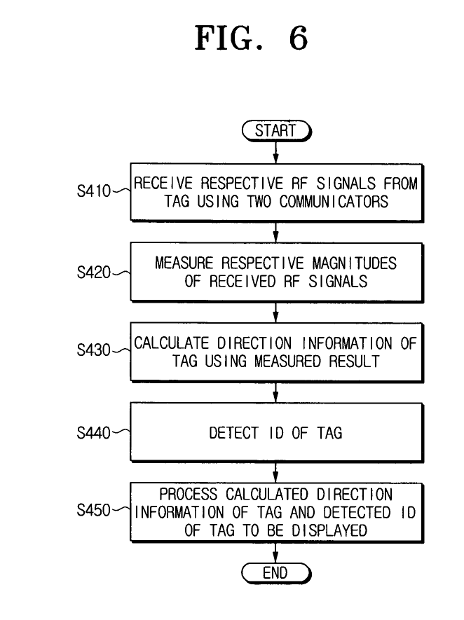

Hereafter, the process of the reader 200 offering the tag direction information as the tag related information will be elucidated with reference to FIGS. 5 and 6. FIG. 5 is a block diagram illustrating a reader, which offers the tag direction information, and a tag according to another exemplary embodiment of the present invention.

The tag 100 illustrated in FIG. 5 is the same as the tag 100 illustrated in FIG. 2, and accordingly, the detailed description thereof will be omitted for the sake of brevity.

The reader 200 comprises a first reader antenna 210-1, a second reader antenna 210-2, a first reader communicator 220-1, a second reader communicator 220-2, a first measurer 230-1, a second measurer 230-2, a controller 240, a reader memory 250, a display information generator 260 and a display 270.

The first reader communicator 220-1 receives an RF signal through the first reader antenna 210-1 from the tag 100, demodulates and digitizes the received signal and transmits the digitized signal to the controller 240, which will be explained below. The first measurer 230-1 measures a magnitude of the RF signal received through the first reader communicator 220-1, and transmits the measured result to the controller 240.

The second reader communicator 220-2 receives the RF signal through the second reader antenna 210-2 from the tag 100, demodulates and digitizes the received signal and transmits the digitized signal to the controller 240, which will be explained below. The second measurer 230-2 measures a magnitude of the RF signal received through the second reader communicator 220-2, and transmits the measured result to the controller 240.

The controller 240 calculates the tag direction information using the measured results received from the first measurer 230-1 and the second measurer 230-2. The controller 240 also detects the ID of the tag 100 from an output signal of the first reader communicator 220-1 or the second reader communicator 220-2.

The display information generator 260 processes the tag direction information, which is calculated by the controller 240, and the ID of tag 100, which is detected by the controller 240, so that the tag direction information and the ID can be displayed on the display 270 for the user's notice.

The reader memory 250 is a recording medium, which stores programs and data necessary for operating the reader 200.

Hereafter, the process of the reader 200 offering the tag direction information will be elucidated with reference to FIG. 6. FIG. 6 is a flowchart for explaining the method for offering the tag direction information according to another exemplary embodiment of the present invention.

Referring to FIG. 6, each of the first reader communicator 220-1 and the second reader communicator 220-2 receives an RF signal from the tag 100 (S410). The first measurer 230-1 and the second measurer 230-2 measure the magnitudes of an RF signal received through the first reader communicator 220-1 and the second reader communicator 220-2, respectively (S420).

The controller 240 calculates the tag direction information using the measured results received from the first measurer 230-1 and the second measurer 230-2 (S430). In detail, the controller 240 may calculate the tag direction information corresponding to the measured results using ‘magnitude-distance table’ pre-stored in the reader memory 250. The ‘magnitude-distance table’ shows 1:1 corresponding relationship between the magnitudes of the RF signals measured by the first measurer 230-1 and the second measurer 230-2, and the tag direction information.

The controller 240 detects the ID of tag 100 from the output signals, which are output after signal-processing by the first reader communicator 220-1 and/or the second reader communicator 220-2 (S440).

The display information generator 260 processes the tag direction information calculated by the controller 240 and the ID of the tag 100 detected by the controller 240 so that the tag direction information and the ID can be displayed on the display 270 (S450).

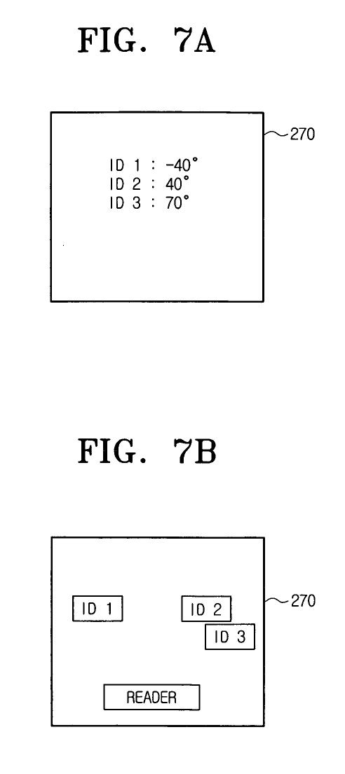

FIG. 7A shows the result of operation S450 when three tags 100-1, 100-2 and 100-3 are located around the reader 200 as illustrated in FIG. 1. Referring to FIG. 7A, the display 270 displays ID1, ID2 and ID3, which are IDs of each tag 100-1, 100-2 and 100-3, together with −40°, 40° and 60°, which are the tag direction information.

When processing the tag direction information such as −40°, 40° and 60° and IDs of tags such as ID1, ID2 and ID3 in the operation S450, the display information generator 260 can illustratively process them using symbols of the tags 100-1, 100-2 and 100-3, and a symbol of the reader 200.

In FIG. 7B, the directions between the symbol of the reader 200 and the symbols of the tags 100-1, 100-2 and 100-3 are adjusted proportionally to the calculated tag direction information. Accordingly, they can be illustratively displayed.

Meanwhile, the operations S410 and S420 may be repeated for a number of times. In the operation S430, the magnitudes of the RF signals may be obtained by several measurements, and the tag direction information can be obtained using the average.

Hitherto, the method of the reader 200 offering the tag distance information or the tag direction information as the tag related information has been in detail explained. Meanwhile, the tag distance information and the tag direction information can be together offered, since this can be easily derived from the two methods according to the above-described exemplary embodiments, the detailed description of the configurations and operations thereof will be omitted for the sake of brevity, and only the result of displaying two information on the display 270 will be explained.

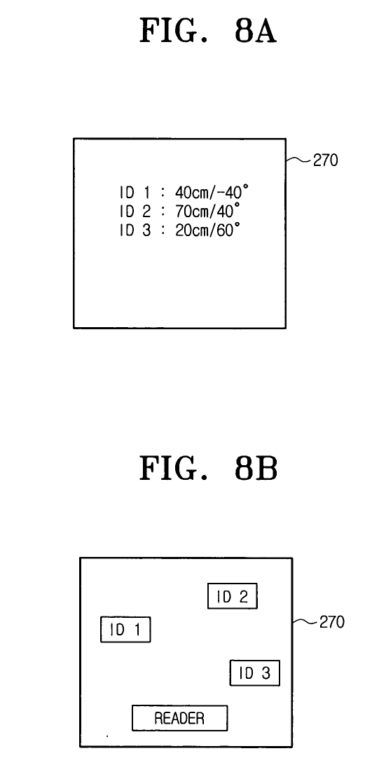

FIG. 8A shows the result of displaying two types of information when three tags 100-1, 100-2 and 100-3 are located around the reader 200 as illustrated in FIG. 1. Referring to FIG. 8A, the display 270 displays ID1, ID2 and ID3, which are IDs of each tag 100-1, 100-2 and 100-3, together with 40 cm/−40°, 70 cm/40° and 20 cm/60°, which are the tag distance information and the tag direction information.

When processing the distance information and direction information of tags such as 40 cm/−40°, 70 cm/40° and 20 cm/60° together with IDs of tags such as ID1, ID2 and ID3 to be displayed, the display information generator 260 can illustratively process them using symbols of the tags 100-1, 100-2 and 100-3, and a symbol of the reader 200.

In FIG. 8B, the distance and the directions between the symbol of the reader 200 and the symbols of the tags 100-1, 100-2 and 100-3 are adjusted according to the calculated tag distance information and tag direction information. Accordingly, they can be illustratively displayed.

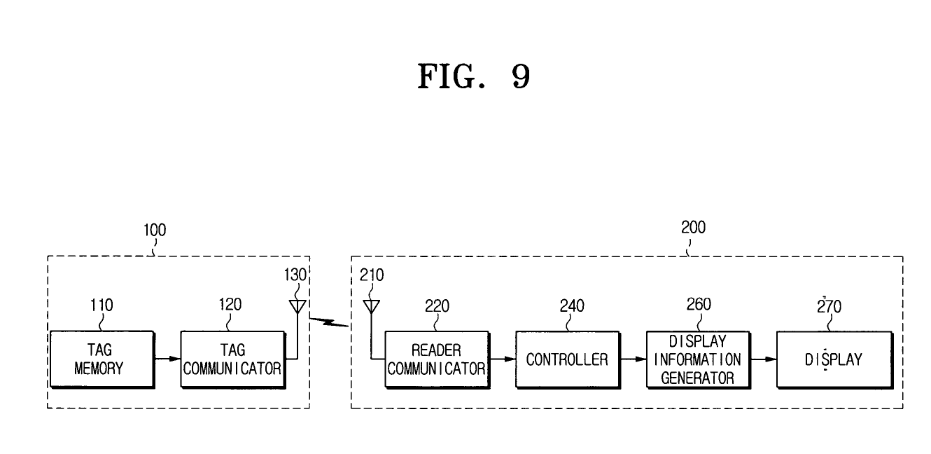

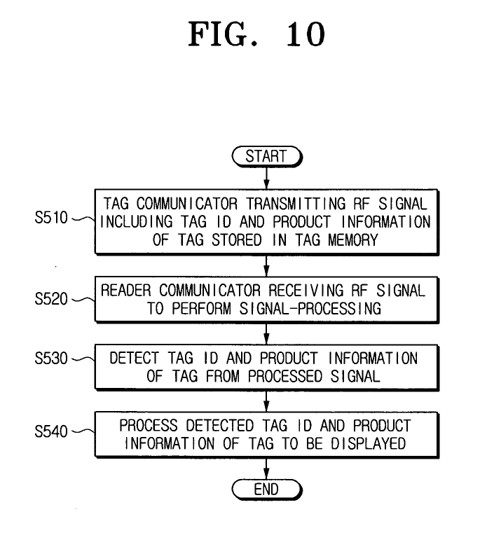

Hereafter, the process of the reader 200 offering the information on the product, to which the tag 100 is attached, (hereafter, referred to ‘product information’) will be elucidated with reference to FIGS. 9 and 10. FIG. 9 is a block diagram illustrating a reader, which offers the product information of tag, and a tag according to yet another exemplary embodiment of the present invention.

Referring to FIG. 9, the tag 100 comprises a tag memory 110, a tag communicator 120 and a tag antenna 130. The tag memory 110 stores therein the product information as well as the tag ID. The tag communicator 120 generates an RF signal including the tag ID and the product information stored in the tag memory 110, and transmits the generated RF signal through the tag antenna 130 to the reader 200.

The reader 200 comprises a reader antenna 210, a reader communicator 220, a controller 240, a display information generator 260 and a display 270.

The reader communicator 220 receives the RF signal through the antenna 210 from the tag 100, demodulates and digitizes the received signal, and transmits the digitized signal to the controller 240, which will be explained below.

The controller 240 detects the tag ID and the product information from the output signal of the reader communicator 220.

The display information generator 260 processes the tag ID and the product information, which are detected by the controller 240, so that the tag ID and the product information can be displayed on the display 270 for the user's notice.

Hereafter, the process of the reader 200 offering the product information of the tag will be elucidated with reference to FIG. 10. FIG. 10 is a flowchart for explaining a method for offering the product information of a tag according to an exemplary embodiment of the present invention.

Referring to FIG. 10, the tag communicator 120 transmits an RF signal to the reader 200 (S510). The RF signal includes the tag ID and the product information of the tag 100 stored in the tag memory 110.

The reader communicator 220 receives the RF signal from the tag 100, demodulates and digitizes the received signal (S520).

The controller 240 detects the tag ID and the product information from the output signal, which is output after signal-processing by the reader communicator 220 (S530).

The display information generator 260 processes the tag ID and the product information, which are detected by the controller 240, so that the tag ID and the product information can be displayed on the display 270 (S540).

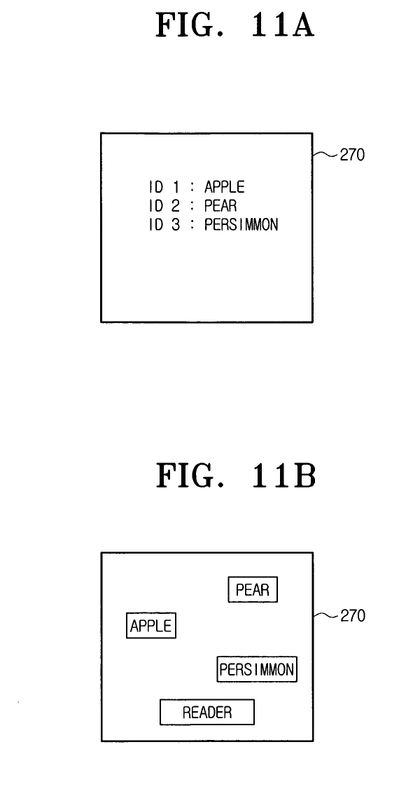

FIG. 11A shows the result of operation S540 when three tags 100-1, 100-2 and 100-3 are located around the reader 200 as illustrated in FIG. 1. Referring to FIG. 11A, the display 270 displays ID1, ID2 and ID3, which are IDs of each tag 100-1, 100-2 and 100-3, together with apple, pear and persimmon, which are the product information of each tag 100-1, 100-2 and 100-3.

The product information may be offered in various foreign languages. To this end, the tag memory 110 may have therein the language information on the product information in addition to the tag ID and the product information.

As aforementioned, the ‘language information’ refers to the language in which the product information is represented. For example, if the product information of the tag is in Korean, the language information is Korean, and if the product information of the tag is in English, the language information is English.

The structure of the tag memory 110 storing the tag ID, the language information and the product information is as below. As can be seen below, the language information and the product information are stored in a user data region where a user is free to store and change the information.

Tag ID

| | |
|---|---|
| User data | Language information (e.g., Korean or English) |
| | Product information of tag (e.g., apple, pear or |
| | persimmon) |

In this case, the tag communicator 120 generates an RF signal and transmits the generated RF signal through the tag antenna 130 to the reader 200. The RF signal includes the tag ID, the language information and the product information stored in the tag memory 110.

The controller 240 of the reader 200 decodes the product information using the language information to obtain the product information in a language perceivable by a user.

Hitherto, the method of the reader 200 offering the product information as the tag related information has been in detail explained. However, the tag related information can be offered including not only the product information but also the tag distance information and tag direction information. Since the method for offering the three types of tag related information together can be easily derived from the above-described exemplary embodiments, the detailed description of the configurations and operations thereof will be omitted for the sake of brevity, but only the result of displaying the information on the display 270 will be explained.

FIG. 1B shows the result of displaying the three types of information when three tags 100-1, 100-2 and 100-3 are located around the reader 200 as illustrated in FIG. 1.

In FIG. 11B, the word ‘reader’ is displayed in a block to symbolically display the reader 200, and the product information of the tags such as apple, pear and persimmon is displayed in blocks to symbolically display the tags 100-1, 100-2 and 100-3. The distance and the direction between the symbol of the reader 200 and the symbols of the tags 100-1, 100-2 and 100-3 are adjusted according to the calculated tag distance information and tag direction information. Accordingly, the distance information and the direction information of the tags 100-1, 100-2 and 100-3 can be illustratively displayed.

Hitherto, the tag distance information and the tag direction information are exemplified as the location information of the tag. However, this should not be considered as limiting and it will be understood that another sorts of the location information of the tag may be employed.

For example, the location information may include a location of the tag on the earth, an address of the tag and a logical location of the tag. The location of the tag on the earth, the address of the tag and the logical location of the tag are stored in the tag memory 110, and transmitted to the reader 200 so that they can be offered to a user. Preferably, but not necessarily, the location of the tag on the earth, the address of the tag and the logical location of the tag may be stored in the user data region of the tag memory 110.

The location of the tag on the earth comprises latitude and longitude of the product with the tag 100, for example, 37-degree 34-minute north latitude and 126-degree 59-minute east longitude.

The address of the tag comprises the address where the product with the tag 100 is located, for example, Samsung department store, Samsung department store food corner, etc.

The logical location of the tag comprises an absolute location of the tag and a relative location of the tag. The absolute location of the tag is a location where location relationship with other products is not considered, for example, the second from the left of the first floor of a display stand. The relative location of the tag is a location where location relationship with other products is considered. For example, if there are three products in the display stand, the relative location of one product may be ‘left’, the relative location of another product may be ‘right’, and the relative location of the other product may be ‘center’.

As described above, according to the exemplary embodiments of the present invention, if a plurality of tags are around the reader 200, the reader 200 can offer the tag related information such as the location information and the product information. Accordingly, even when the plurality of tags exist around the reader, a user can identify tags with the IDs read by the reader 200.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A radio frequency identification (RFID) reader comprising:
a communicator which receives a radio frequency (RF) signal from an RFID tag;
a controller which calculates location information of the RFID tag based on the RF signal; and
a display information generator which processes the location information of the RFID tag for display.

2. The RFID reader as claimed in claim 1,
wherein the location information of the RFID tag comprises at least one of distance information and direction information, and
wherein the distance information is information regarding a distance between the RFID tag and the RFID reader, and the direction information is information regarding a direction of the RFID reader toward the RFID tag.

3. The RFID reader as claimed in claim 2, further comprising:
a measurer which measures a magnitude of the RF signal received through the communicator,
wherein the controller calculates the at least one of the distance information and the direction information using the magnitude of the RF signal.

4. The RFID reader as claimed in claim 3, wherein the controller calculates the at least one of the distance information and the direction information using an average of magnitudes of the RF signal which are measured for a plurality of times by the measurer.

5. The RFID reader as claimed in claim 1,
wherein the location information of the RFID tag comprises at least one of a location of the RFID tag on the earth, an address of a product to which the RFID tag is attached, an absolute location of the RFID tag and a relative location of the RFID tag, and
wherein the absolute location is a location where location relationship with another product is not considered and the relative location is a location where the location relationship with another product is considered.

6. The RFID reader as claimed in claim 5, wherein the location information of the RFID tag is stored in a memory of the RFID tag, and the RF signal comprises the location information of the RFID tag.

7. The RFID reader as claimed in claim 1, wherein the display information generator processes the location information of the RFID tag such that the location information of the RFID tag is displayed on a display using a symbol of the RFID tag and a symbol of the RFID reader.

8. The RFID reader as claimed in claim 1,
wherein the controller detects product information which is information on a product to which the RFID tag is attached, and included in the RF signal, and
wherein the display information generator processes the product information such that the product information is displayed together with the location information of the RFID tag on a display.

9. A radio frequency identification (RFID) reader comprising:
a communicator which receives a radio frequency (RF) signal comprising product information, which is information on a product to which an RFID tag is attached, from the RFID tag;
a controller which detects the product information from the RF signal; and
a display information generator which processes the product information for display.

10. The RFID reader as claimed in claim 9, wherein the product information, which is included in the RF signal, is stored in a memory of the RFID tag.

11. The RFID reader as claimed in claim 9,
wherein the RF signal further comprises language information on the information on the product, the language information indicating a language which the product information is represented in,
wherein the controller decodes the product information using the language information to obtain the product information in a selected language, and
wherein the display information generator processes the decoded product information such that the product information is displayed on a display in the selected language.

12. A radio frequency identification (RFID) tag comprising:
a memory which stores product information, which is information on a product to which an RFID tag is attached; and
a communicator which generates a radio frequency (RF) signal comprising the product information, and transmits the RF signal to an RFID reader.

13. The RFID tag as claimed in claim 12,
wherein the memory further stores language information on the product information, and the RF signal further comprises the language information, and
wherein the language information indicates a language which the product information is represented in.

14. A radio frequency identification (RFID) reader comprising:
a communicator which receives a radio frequency (RF) signal from an RFID tag, wherein the RF signal comprises at least one of an identification (ID) of the RFID tag, location information on the RFID tag and information on a product to which the RFID tag is attached;
a controller which performs at least one of detection of the ID, calculation of the location information and detection of the information on the product based on the RF signal; and
a display information generator which processes the at least one of the ID, the location information and the information on the product such that the at least one of the ID, the location information and the information on the product is displayed on a display.

15. A method for offering radio frequency identification (RFID) tag related information, the method comprising:
receiving a radio frequency (RF) signal from an RFID tag;
calculating location information of the RFID tag on the basis of the received RF signal; and
processing the location information of the RFID tag such that the location information of the RFID tag is displayed.

16. The method as claimed in claim 15,
wherein the location information of the RFID tag comprises at least one of distance information and direction information, and
wherein the distance information is information regarding a distance between the RFID tag and the RFID reader, and the direction information is information regarding a direction of the RFID reader toward the RFID tag.

17. The method as claimed in claim 16, wherein the calculating of the location information comprises:
measuring a magnitude of the received RF signal; and
calculating at least one of the distance information and the direction information using the magnitude of the RF signal.

18. The method as claimed in claim 17, wherein, the at least one of the distance information and the direction information is calculated based on an average of magnitudes of the RF signal, which are measured for a plurality of times.

19. The method as claimed in claim 15,
wherein the location information of the RFID tag comprises at least one of a location of the RFID tag on the earth, an address of a product to which the RFID tag is attached, an absolute location of the RFID tag, and a relative location of the RFID tag, and
wherein the absolute location is a location where location relationship with another products is not considered and the relative location is a location where the location relationship with another products is considered.

20. The method as claimed in claim 19, wherein the location information of the RFID tag is stored in a memory of the RFID tag, and the RF signal comprises the location information of the RFID tag.

21. The method as claimed in claim 15, wherein, the processing of the location information processes the location information of the RFID tag to be displayed using a symbol of the RFID tag and a symbol of the RFID reader.

22. The method as claimed in claim 15, further comprising:
detecting product information, which is information on a product to which the RFID tag is attached, and included in the RF signal; and
processing the product information such that the product information is displayed together with the location information of the RFID tag.

23. A method for offering radio frequency identification (RFID) tag related information, the method comprising:
receiving a radio frequency (RF) signal comprising product information, which is information on a product to which an RFID tag is attached, from the RFID tag;
detecting the product information from the RF signal; and
processing the product information for display.

24. The method as claimed in claim 23, wherein the product information, which is included in the received RF signal, is stored in a memory of the RFID tag.

25. The method as claimed in claim 23,
wherein the RF signal further comprises language information on the information on the product, the language information indicating a language which the product information is represented in;
wherein the detecting of the product information comprises decoding the product information using the language information to obtain the product information in a selected language; and
wherein the product information is displayed in the selected language.
